(19) United States
(12) Patent Application Publication
(10) Pub. No.: US 2026/0011997 A1
(43) Pub. Date: Jan. 8, 2026

(54) CABLE WIRE HAVING OPPOSITE FLAT SURFACES

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: JIM ZHAO, Irvine, CA (US); HAOZHE ZI, Irvine, CA (US); JESSE LI, Anaheim, CA (US); AN-JEN YANG, Irvine, CA (US)

(21) Appl. No.: 19/257,986

(22) Filed: Jul. 2, 2025

Related U.S. Application Data
(60) Provisional application No. 63/667,675, filed on Jul. 3, 2024.

(51) Int. Cl. H02G 15/02

(52) U.S. Cl. CPC H02G 15/02

(57) ABSTRACT

A cable wire includes a center conductor having a terminating end and an insulator enclosing the center conductor while exposing the terminating end, wherein the terminating end has a top flat surface and an opposite bottom flat surface.

### CROSS REFERENCE TO RELATED APPLICATION

This application claims priority to and benefit of U.S. Provisional Patent Application No. 63/667,675, filed Jul. 3, 2024.

### BACKGROUND OF THE INVENTION

### Field of the Invention

The present invention relates to a cable wire comprising a center conductor having a terminating end and an insulator enclosing the center conductor while exposing the terminating end, wherein the terminating end is shaped for impedance control and joint strength.

### Description of Related Arts

U.S. Patent Application Publication No. 2023/0028514 discloses a cable wire which has a cylindrical portion terminating with a taper to an end so that the end has a smaller diameter than the cylindrical portion. The cable wire is essentially formed by heating and pulling the end to obtain the taper.

### SUMMARY OF THE INVENTION

A cable wire comprises a center conductor having a terminating end; and an insulator enclosing the center conductor while exposing the terminating end, wherein the terminating end has a top flat surface and an opposite bottom flat surface.

### BRIEF DESCRIPTION OF DRAWINGS

FIG. 1 is a top perspective view of a cable wire in accordance with a first embodiment of the present invention;

FIG. 2 is a bottom perspective view of the cable wire;

FIG. 3 is a top view of the cable wire;

FIG. 4 is a bottom view of the cable wire;

FIG. 5 is a side view of the cable wire;

FIG. 6 is a top perspective view of a cable wire in accordance with a second embodiment of the present invention;

FIG. 7 is a bottom perspective view of the cable wire in FIG. 6;

FIG. 8 is a top view of the cable wire in FIG. 6;

FIG. 9 is a bottom view of the cable wire in FIG. 6;

FIG. 10 is a side view of the cable wire in FIG. 6;

FIG. 11 is a top perspective view of a cable wire in accordance with a third embodiment of the present invention;

FIG. 12 is a bottom perspective view of the cable wire in FIG. 11;

FIG. 13 is a top view of the cable wire in FIG. 11;

FIG. 14 is a bottom view of the cable wire in FIG. 11;

FIG. 15 is a side view of the cable wire in FIG. 11;

FIG. 16 is a view showing reference dimension of the cable wire according to the first embodiment;

FIG. 17 is a view showing reference dimension of the cable wire according to the second embodiment;

FIG. 18 is a view showing reference dimension of the cable wire according to the third embodiment;

FIG. 19 is a view showing different termination schemes; and

FIG. 20 is a side view showing features of a cable wire of the present invention.

### DETAILED DESCRIPTION OF THE DRAWINGS

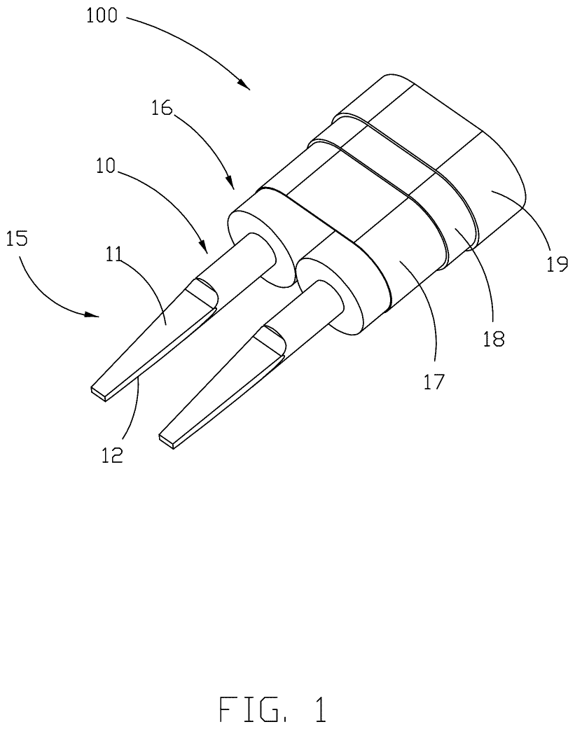

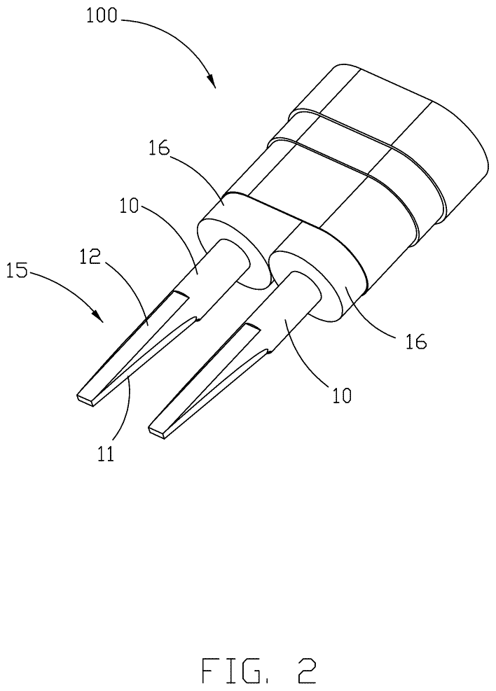

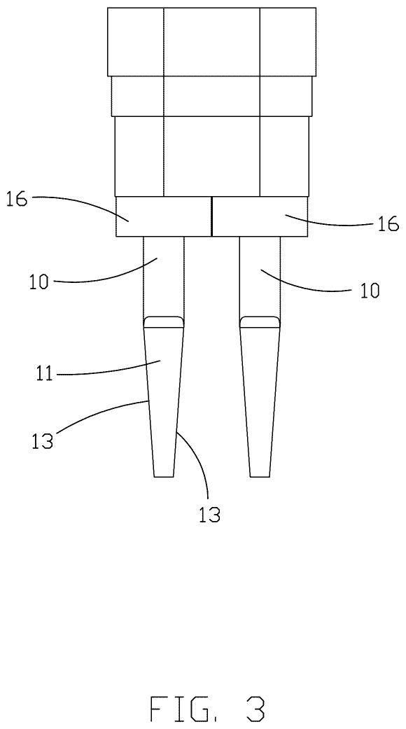

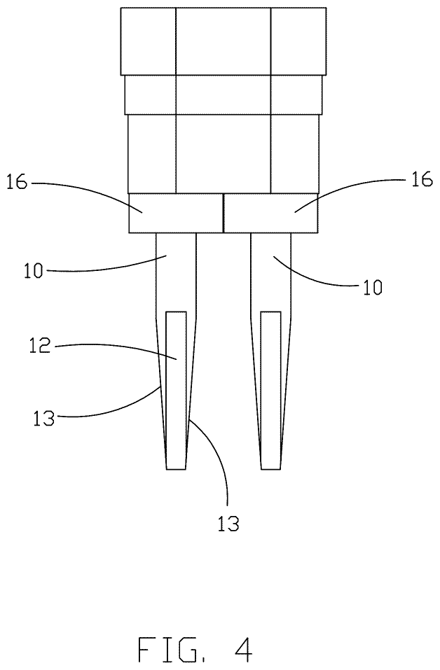

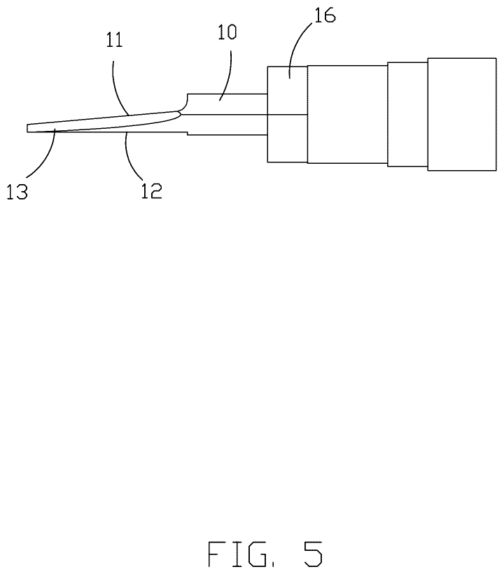

Referring to FIGS. 1-5, a cable wire of a first embodiment comprises a center conductor 10 having a terminating end 15 and an insulator 16 enclosing the center conductor 10 while exposing the terminating end 15. In the embodiment shown, a pair of cable wires constitute a so-called twin-ax 100 which as is well known in this art may further include a shielding layer 17 wrapping around the pair of insulators 16, another layer 18 wrapping around the shielding layer 17, and an outer jacket 18.

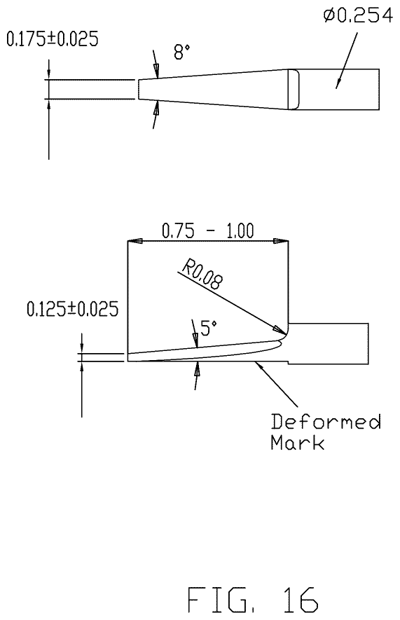

The terminating end 15 has a top flat surface 11 and an opposite bottom flat surface 12. As can be understood, the bottom flat surface 12 is to be terminated to, for example, a conductive pad of a printed circuit board. The top flat surface 11 is non-parallel to the bottom flat surface 12. Specifically, the bottom flat surface 12 is horizontal while the top flat surface 11 is tapered. The terminating end 15 has a pair of tapered side surfaces 13 converging toward a free end thereof. A reference dimension of the terminating end 15 in inches is given in FIG. 16.

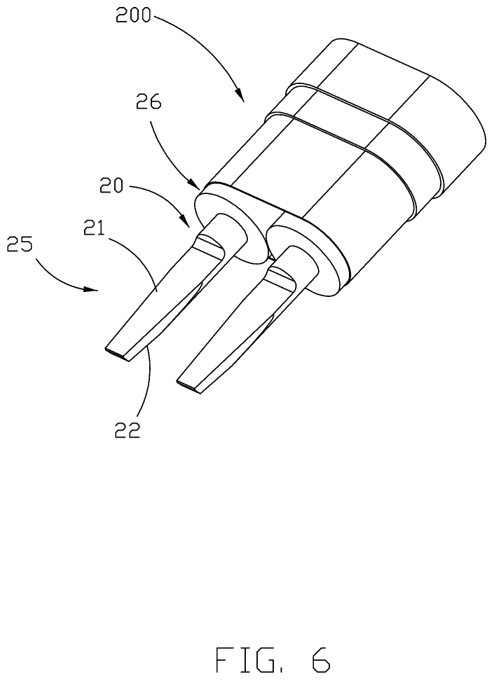

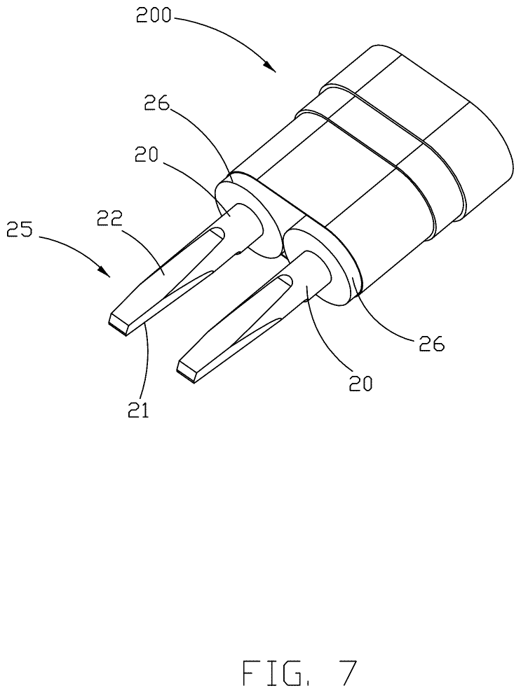

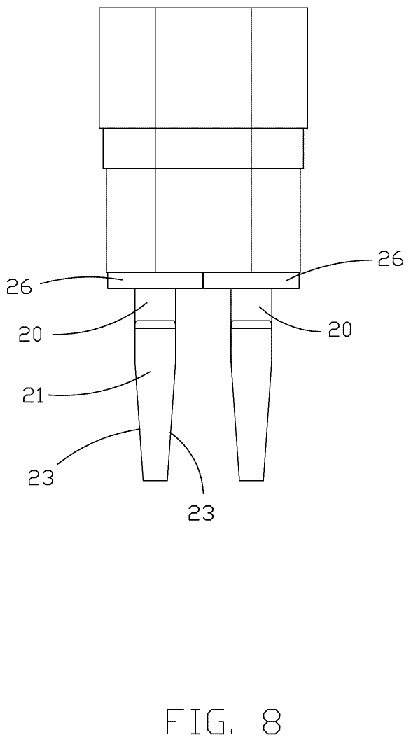

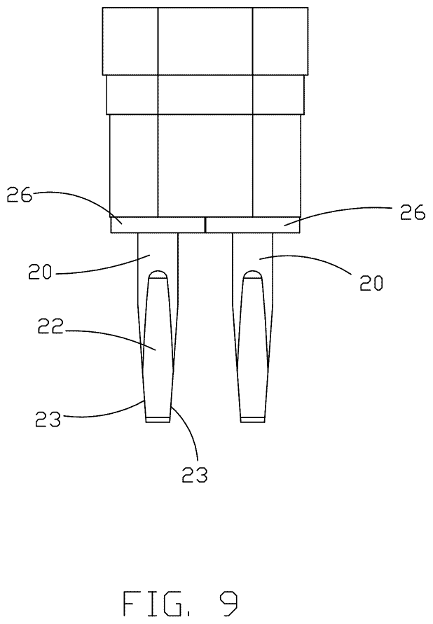

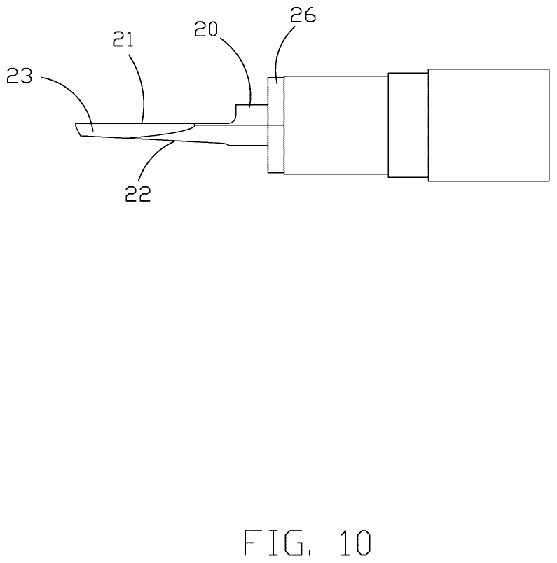

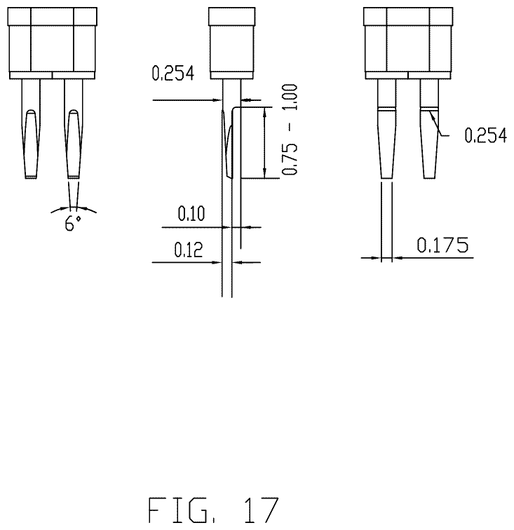

Referring to FIGS. 6-10, a cable wire of a second embodiment comprises a center conductor 20 having a terminating end 25 and an insulator 26 enclosing the center conductor 20 while exposing the terminating end 25. In the embodiment shown, a pair of cable wires constitute a twin-ax 200. The terminating end 25 has a top flat surface 21 and an opposite bottom flat surface 22. The top flat surface 21 is non-parallel to the bottom flat surface 22. Specifically, the top flat surface 21 is horizontal while the bottom flat surface 22 is tapered. The terminating end 25 has a pair of tapered side surfaces 23 converging toward a free end thereof. A reference dimension of the terminating end 25 in inches is given in FIG. 17.

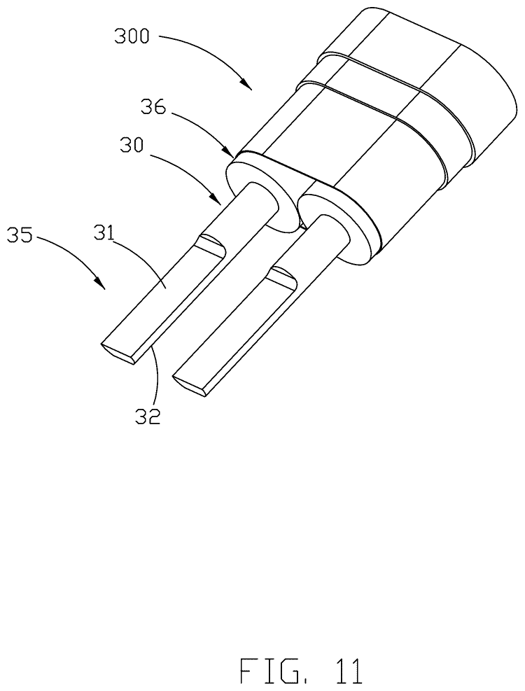

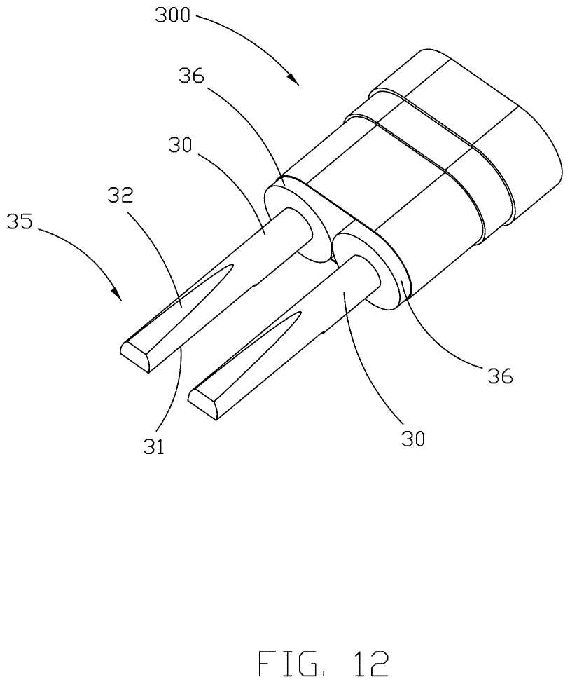

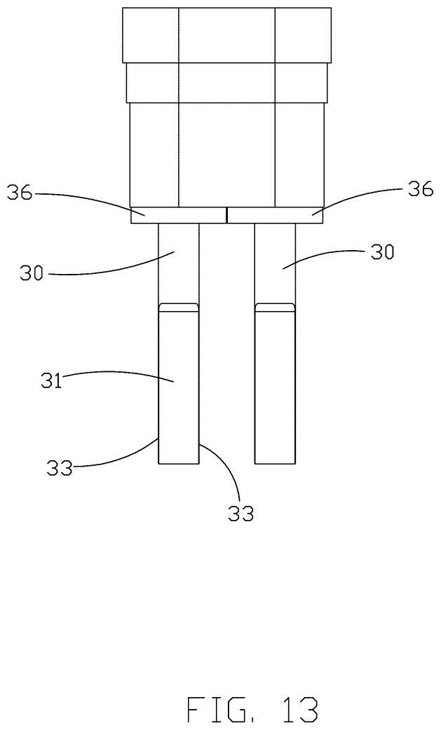

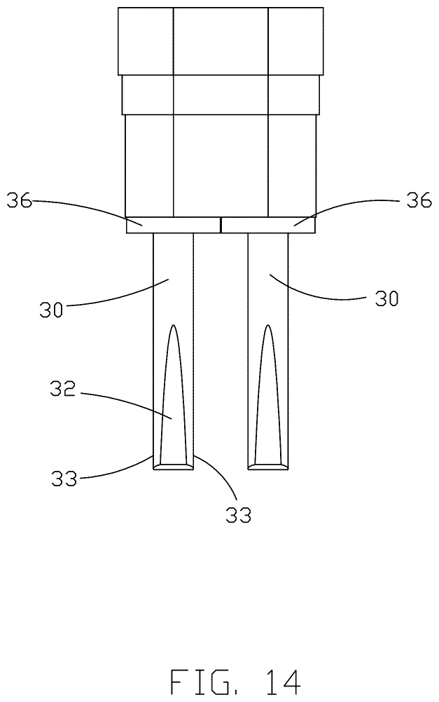

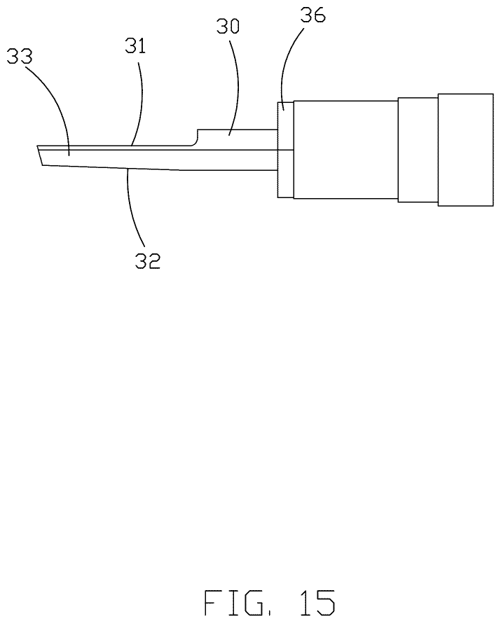

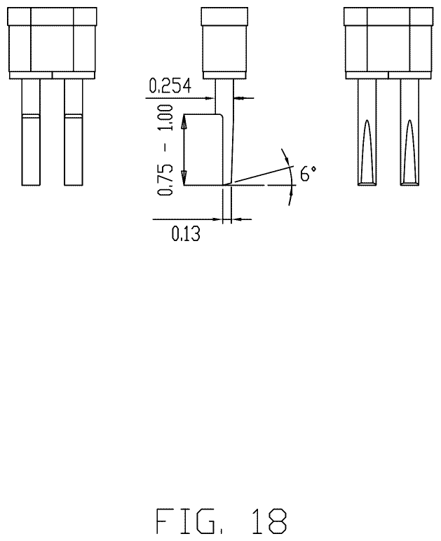

Referring to FIGS. 11-15, a cable wire of a third embodiment comprises a center conductor 30 having a terminating end 35 and an insulator 36 enclosing the center conductor 30 while exposing the terminating end 35. In the embodiment shown, a pair of cable wires constitute a twin-ax 300. The terminating end 35 has a top flat surface 31 and an opposite bottom flat surface 32. The top flat surface 31 is non-parallel to the bottom flat surface 32. Specifically, the top flat surface 31 is horizontal while the bottom flat surface 32 is tapered. The terminating end 35 has a pair of non-tapered side surfaces 33. A reference dimension of the terminating end 35 in inches is given in FIG. 18.

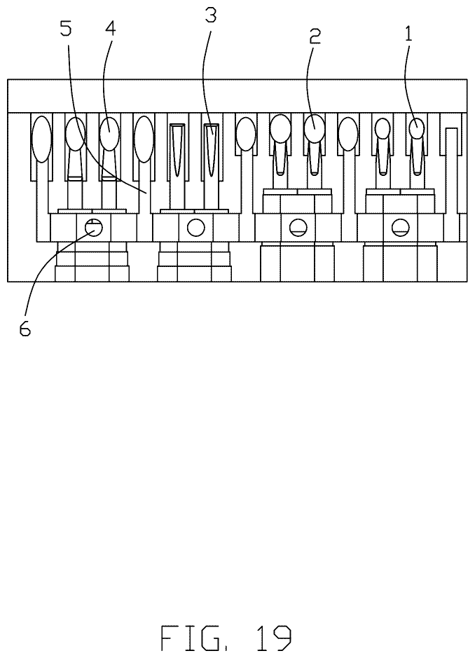

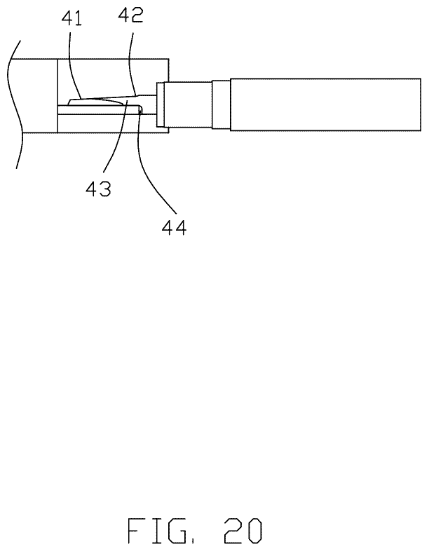

FIG. 19 shows renderings from different termination methods. Reference numeral 1 represents Laser Welding, reference numeral 2 represents Laser Bumping, reference numeral 3 represents Resistance Welding, reference numeral 4 represents Hot Bar Magnetic Reflow SMT Reflow Automatic Robot, reference numeral 5 represents Ground Bar, and reference numeral 6 represents Soldering Winder. FIG. 20 shows a terminating end of a cable wire on an edge of a printed circuit board where a structure of thinner portion 41 for better reflow, thicker portion 42 for strength, deformed length 43 for better signal integrity, and epoxy 44 for wire positioning is seen.

1. A cable wire comprising:
a center conductor having a terminating end; and
an insulator enclosing the center conductor while exposing the terminating end; wherein
the terminating end has a top flat surface and an opposite bottom flat surface.

2. The cable wire as claimed in claim 1, wherein the top flat surface is non-parallel to the bottom flat surface.

3. The cable wire as claimed in claim 2, wherein the bottom flat surface is horizontal while the top flat surface is tapered.

4. The cable wire as claimed in claim 3, wherein the angle between the top flat surface and the bottom flat surface is about 5 degrees.

5. The cable wire as claimed in claim 1, wherein the terminating end comprises a pair of tapered side surfaces converging toward a free end thereof.

6. The cable wire as claimed in claim 5, wherein a angle between the pair of tapered side surfaces is 6-8 degrees.

7. The cable wire as claimed in claim 6, wherein a angle between the pair of tapered side surfaces is about 6 degrees.

8. The cable wire as claimed in claim 6, wherein a angle between the pair of tapered side surfaces is about 8 degrees.

9. The cable wire as claimed in claim 1, wherein the terminating end has a pair of non-tapered side surfaces.

10. The cable wire as claimed in claim 1, wherein the cable includes a pair of center conductors arranged at intervals, and two insulators respectively wrapped around the center conductors.

11. The cable wire as claimed in claim 10, further comprising a shielding layer wrapping around the two insulators, another layer wrapping around the shielding layer, and an outer jacket wrapping around the another layer.

12. The cable wire as claimed in claim 1, wherein a cross-sectional shape of the center conductor is circular except for the terminating end, and the length dimension of a cross-sectional shape of the terminating end is not greater than the diameter of the circular central conductor.

13. The cable wire as claimed in claim 12, wherein the terminating end comprising a thinner portion for better reflow and thicker portion for strength.

14. The cable wire as claimed in claim 12, wherein a deformed length of the terminating end is about 0.75-1.0 inch.

15. A cable wire comprising:
a pair of center conductors each having a terminating end; and
an insulator enclosing the pair of center conductors while exposing the terminating ends; wherein
each of the terminating end has a top flat surface and an opposite bottom flat surface.

16. The cable wire as claimed in claim 15, wherein the top flat surface is non-parallel to the bottom flat surface.

17. The cable wire as claimed in claim 16, wherein the bottom flat surface is horizontal while the top flat surface is tapered.

18. The cable wire as claimed in claim 15, further comprising a shielding layer wrapping around the two insulators, another layer wrapping around the shielding layer, and an outer jacket wrapping around the another layer.

19. A cable assembly comprising:
a cable wire comprising:
a center conductor having a terminating end; and
an insulator enclosing the center conductor while exposing the terminating end; and
a mating component having a horizontal surface, wherein
the terminating end has a bottom flat surface matched with the horizontal surface and an opposite top flat surface.

20. The cable assembly as claimed in claim 19, wherein the bottom flat surface is horizontal while the top flat surface is tapered.
